(19) United States
(12) Patent Application Publication
(10) Pub. No.: US 2025/0188270 A1
(43) Pub. Date: Jun. 12, 2025

(54) Thermoplastic Copolyester Elastomer Toughened Polyester

(71) Applicant: Celanese Polymers Holding, Inc., Wilmington, DE (US)

(72) Inventors: Carmen Covelli, Chadds Ford, PA (US); Edward Maxwell De Brant Smith, Wilmington, DE (US)

(21) Appl. No.: 18/973,201

(22) Filed: Dec. 9, 2024

Related U.S. Application Data
(60) Provisional application No. 63/607,625, filed on Dec. 8, 2023.

(51) Int. Cl. C08L 67/02; C08K 7/14

(52) U.S. Cl. CPC C08L 67/02; C08K 7/14; C08L 2205/025; C08L 2205/035; C08L 2207/04

(57) ABSTRACT

A polyester composition is disclosed. The polyester composition comprises: a polyester in an amount of from about 10 wt. % or more to about 75 wt. % or less based on the weight of polyester composition; a thermoplastic copolyester elastomer containing hard segments and soft segments, wherein the thermoplastic copolyester elastomer is present in an amount of from about 3 wt. % or more to about 40 wt. % or less based on the weight of the polyester composition; and a fibrous filler in an amount of from about 1 wt. % or more to about 40 wt. % or less based on the weight of the polyester composition; wherein the polyester composition exhibits an Izod notched impact strength of from 5 kJ/m² or more to 40 kJ/m² or less as determined at a temperature of 23° C. in accordance with ISO 180/A1 (2006).

### CROSS-REFERENCE TO RELATED APPLICATION

The present application claims filing benefit of U.S. Provisional Patent Application No. 63/607,625 having a filing date of Dec. 8, 2023, which is incorporated herein by reference in its entirety.

### BACKGROUND

Engineering thermoplastics are often used in numerous and diverse applications in order to produce molded parts/articles. For instance, polyesters are used to produce all different types of molded parts/articles, such as injection molded products, blow molded products, and the like. Polyesters, for instance, can be formulated in order to be chemically resistant and to have excellent strength properties. Of particular advantage, polyesters can be melt processed due to their thermoplastic nature. In addition, polyesters can be recycled and reprocessed.

Polyester compositions are particularly well suited to producing molded articles of any suitable shape or dimension. The molded articles can be made through injection molding, thermoforming, or any other suitable melt processing method. For certain applications, it is desired for the polyester composition to be relatively tough with certain desired mechanical properties. In this regard, various different additives and components, such as reinforcements, may be added to increase the toughness and impact strength of the polyester polymers. However, in certain applications, such additives may not necessarily be desired due to their chemical nature and/or the desired properties, in particular mechanical properties, may not be realized.

As such, a need currently exists for providing an improved toughened polyester composition.

### SUMMARY OF THE DISCLOSURE

In accordance with one embodiment of the present disclosure, a polyester composition is disclosed. The polyester composition comprises: a polyester in an amount of from about 10 wt. % or more to about 75 wt. % or less based on the weight of polyester composition; a thermoplastic copolyester elastomer containing hard segments and soft segments, wherein the thermoplastic copolyester elastomer is present in an amount of from about 3 wt. % or more to about 40 wt. % or less based on the weight of the polyester composition; and a fibrous filler in an amount of from about 1 wt. % or more to about 40 wt. % or less based on the weight of the polyester composition; wherein the polyester composition exhibits an Izod notched impact strength of from 5 kJ/m² or more to 40 kJ/m² or less as determined at a temperature of 23° C. in accordance with ISO 180/A1 (2006).

Other features and aspects of the present disclosure are set forth in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 provides TEM images of the samples of Example 2.

FIG. 2 provides TEM images of the samples of Example 3.

FIG. 3 provides TEM images of the samples of Example 4.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a thermoplastic copolyester elastomer toughened polyester. The present inventors have discovered that by utilizing a polyester with a thermoplastic copolyester elastomer along with a fibrous filler as disclosed herein, a polyester composition having the desired properties for various applications can be obtained. In particular, by utilizing such components as disclosed herein, a resulting article may have improved mechanical properties and toughness.

For instance, the polyester composition may have a certain Izod notched impact strength. In particular, the Izod notched impact strength may be a relatively high impact strength. In this regard, the Izod notched impact strength may be about 5 kJ/m² or more, such as about 6 kJ/m² or more, such as about 7 KJ/m² or more, such as about 8 kJ/m² or more, such as about 9 kJ/m² or more, such as about 10 kJ/m² or more, such as about 11 kJ/m² or more, such as about 12 kJ/m² or more, such as about 13 kJ/m² or more. The Izod notched impact strength may be about 40 kJ/m² or less, such as about 36 kJ/m² or less, such as about 33 kJ/m² or less, such as about 30 kJ/m² or less, such as about 28 kJ/m² or less, such as about 25 kJ/m² or less, such as about 22 kJ/m² or less, such as about 20 kJ/m² or less, such as about 18 kJ/m² or less, such as about 16 kJ/m² or less, such as about 14 kJ/m² or less, such as about 13 kJ/m² or less, such as about 12 kJ/m² or less, such as about 11 kJ/m² or less, such as about 10 kJ/m² or less. The Izod notched impact strength may be determined at a temperature of 23° C. in accordance with ISO 180/A1 (2006).

In addition, the polyester composition may have a certain tensile strength. In particular, the tensile strength may be about 10 MPa or more, such as about 20 MPa or more, such as about 30 MPa or more, such as about 40 MPa or more, such as about 50 MPa or more, such as about 55 MPa or more, such as about 60 MPa or more, such as about 65 MPa or more, such as about 70 MPa or more, such as about 80 MPa or more, such as about 90 MPa or more, such as abou5 100 MPa or more, such as about 110 MPa or more, such as about 120 MPa or more, such as about 130 MPa or more, such as about 140 MPa or more. The tensile strength may be about 300 MPa or less, such as about 250 MPa or less, such as about 200 MPa or less, such as about 180 MPa or less, such as about 160 MPa or less, such as about 150 MPa or less, such as about 140 MPa or less, such as about 130 MPa or less, such as about 120 MPa or less, such as about 110 MPa or less, such as about 100 MPa or less, such as about 90 MPa or less, such as about 80 MPa or less, such as about 70 MPa or less, such as about 60 MPa or less. The tensile strength may be determined at a temperature of 23° C. in accordance with ISO Test No. 527:2012.

Also, the polyester composition may have a certain tensile elongation. In particular, the tensile elongation may be about 0.3% or more, such as about 0.4% or more, such as about 0.5% or more, such as about 0.6% or more, such as about 0.8% or more, such as about 1% or more, such as about 1.2% or more, such as about 1.4% or more, such as about 1.6% or more, such as about 1.8% or more, such as about 2% or more, such as about 2.2% or more, such as about 2.4% or more, such as about 2.6% or more, such as about 2.8% or more, such as about 3% or more. The tensile elongation may be about 8% or less, such as about 6% or less, such as about 5% or less, such as about 4% or less, such as about 3.5% or less, such as about 3% or less, such as about 2.8% or less, such as about 2.6% or less, such as about 2.4% or less, such as about 2.2% or less, such as about 2% or less, such as about 1.8% or less, such as about 1.6% or less, such as about 1.5% or less, such as about 1.4% or less, such as about 1.3% or less, such as about 1.2% or less, such as about 1.1% or less. The tensile elongation may be determined at a temperature of 23° C. in accordance with ISO Test No. 527:2012.

Further, the polyester composition may have a certain tensile modulus. In particular, the tensile modulus may be about 5,000 MPa or more, such as about 6,000 MPa or more, such as about 6,500 MPa or more, such as about 7,000 MPa or more, such as about 7,500 MPa or more, such as about 8,000 MPa or more, such as about 8,500 MPa or more, such as about 9,000 MPa or more, such as about 9,500 MPa or more, such as about 10,000 MPa or more. The tensile modulus may be about 20,000 MPa or less, such as about 18,000 MPa or less, such as about 16,000 MPa or less, such as about 14,000 MPa or less, such as about 12,000 MPa or less, such as about 10,000 MPa or less, such as about 9,000 MPa or less, such as about 8,000 MPa or less, such as about 7,000 MPa or less. The tensile modulus may be determined at a temperature of 23° C. in accordance with ISO Test No. 527:2012.

In addition to the mechanical properties, the thermoplastic copolyester elastomer demonstrates good dispersion within the polyester matrix. For instance, the polyester may for a matrix or continuous phase and the thermoplastic copolyester elastomer may form domains in a dispersed or discontinuous phase. In this regard, the domains of the thermoplastic copolyester elastomer, which may form a discontinuous phase, are generally well dispersed throughout the polyester, which may form a continuous phase.

In general, the dispersed phase of the thermoplastic copolyester elastomer may be presented as any shape and is thus not necessarily limited by the present disclosure. For instance, the domains may have a variety of different shapes, such as elliptical, spherical, cylindrical, etc.

In this regard, the average domain size, based on the longest dimension of each domain, may be about 0.05 μm or more, about 0.1 μm or more, such as about 0.2 μm or more, such as about 0.3 μm or more, such as about 0.4 μm or more, such as about 0.5 μm or more, such as about 0.6 μm or more, such as about 0.7 μm or more, such as about 0.8 μm or more, such as about 0.9 μm or more, such as about 1 μm or more, such as about 1.2 μm or more, such as about 1.4 μm or more, such as about 1.6 μm or more, such as about 1.8 μm or more, such as about 2 μm or more, such as about 2.2 μm or more, such as about 2.4 μm or more, such as about 2.6 μm or more, such as about 2.8 μm or more, such as about 3 μm or more. The average domain size, based on the longest dimension of each domain, may be about 10 μm or less, such as about 9 μm or less, such as about 8 μm or less, such as about 7 μm or less, such as about 6 μm or less, such as about 5 μm or less, such as about 4.7 μm or less, such as about 4.3 μm or less, such as about 4 μm or less, such as about 3.8 μm or less, such as about 3.6 μm or less, such as about 3.4 μm or less, such as about 3.2 μm or less, such as about 3 μm or less, such as about 2.8 μm or less, such as about 2.6 μm or less, such as about 2.4 μm or less, such as about 2.2 μm or less, such as about 2 μm or less, such as about 1.8 μm or less, such as about 1.6 μm or less, such as about 1.4 μm or less, such as about 1.2 μm or less, such as about 1 μm or less, such as about 0.9 μm or less, such as about 0.8 μm or less, such as about 0.7 μm or less, such as about 0.6 μm or less, such as about 0.5 μm or less.

In one embodiment, at least 50%, such as at least 60%, such as at least 70%, such as at least 80% of the domains may fall within a particular domain size range as mentioned above. For instance, such domains may be relatively smaller domains. As an example, at least 50%, such as at least 60%, such as at least 70%, such as at least 80% of the domains may fall within a domain size (i.e., longest dimension of the domain) of from about 0.05 μm or more, about 0.1 μm or more, such as about 0.2 μm or more, such as about 0.3 μm or more, such as about 0.4 μm or more, such as about 0.5 μm or more, such as about 0.6 μm or more, such as about 0.7 μm or more, such as about 0.8 μm or more, such as about 0.9 μm or more, such as about 1 μm or more to about 2 μm or less, such as about 1.8 μm or less, such as about 1.6 μm or less, such as about 1.4 μm or less, such as about 1.2 μm or less, such as about 1 μm or less, such as about 0.9 μm or less, such as about 0.8 μm or less, such as about 0.7 μm or less, such as about 0.6 μm or less, such as about 0.5 μm or less.

Related, less than 50%, such as less than 40%, such as less than 30%, such as less than 20%, such as less than 10% of the domains may fall within another particular domain size range as mentioned above. For instance, such domains may be relatively larger domains. As an example, less than 50%, such as less than 40%, such as less than 30%, such as less than 20%, such as less than 10% of the domains may fall within a domain size (i.e., longest dimension of the domain) of from about 1 μm or more, such as about 1.2 μm or more, such as about 1.4 μm or more, such as about 1.6 μm or more, such as about 1.8 μm or more, such as about 2 μm or more, such as about 2.2 μm or more, such as about 2.4 μm or more, such as about 2.6 μm or more, such as about 2.8 μm or more, such as about 3 μm or more to about 10 μm or less, such as about 9 μm or less, such as about 8 μm or less, such as about 7 μm or less, such as about 6 μm or less, such as about 5 μm or less, such as about 4.7 μm or less, such as about 4.3 μm or less, such as about 4 μm or less, such as about 3.8 μm or less, such as about 3.6 μm or less, such as about 3.4 μm or less, such as about 3.2 μm or less, such as about 3 μm or less, such as about 2.8 μm or less, such as about 2.6 μm or less, such as about 2.4 μm or less, such as about 2.2 μm or less, such as about 2 μm or less.

The average domain size may be determined using scanning electron microscopy (SEM) or transmission electron microscopy (TEM). In particular, at least 3 images of the polyester composition may be analyzed. Images acquired using TEM would yield superior contrast and resolution. Sample fabrication procedure is dependent on the preferred imaging technique. In the case of TEM sample preparation, thin sectioning via ultra-microtomy at cryogenic temperatures with a diamond knife (>70 μm sections) may be conducted. Bright field TEM micrographs at 200 kv and a magnification of ˜5000X show enough domains to complete image analysis. Image analysis software, such as “Scion Image” or “ImageJ” used on images of adequate contrast, can apply a threshold to remove background, and highlight domain particles. This process provides accurate average area (i.e., size) measurements of the dispersed domains within the thermoplastic copolyester elastomer.

Various embodiments of the present disclosure will now be described in more detail.

### I. Polyester Composition

In general, the polyester composition as disclosed herein is formed from a polyester, a thermoplastic copolyester elastomer, and a fibrous filler. The polyester composition may also include other optional additives as defined herein and/or generally known in the art. For instance, these may include, but are not limited to, an ethylene acrylic acid copolymer, an epoxy resin, a lubricant (e.g., a glycol ester), a pigment (e.g., a black pigment such as carbon black), and/or one or more stabilizers such as antioxidants (e.g., phenolic antioxidant and/or phosphite antioxidant).

### A. Polyester

As indicated above, the polyester composition includes a polyester. For instance, the polyester composition may include one or more polyesters. The polyester may be a thermoplastic polyester, a thermoset polyester, or a mixture thereof. In one embodiment, the polyester may be a thermoplastic polyester. In another embodiment, the polyester may be a thermoset polyester.

In general, the polyester may be derived from a diol having from 2 to 10 carbon atoms. For instance, such diol may be an aliphatic diol, a cycloaliphatic diol, or a mixture thereof. In one embodiment, such diol may be an aliphatic diol. In addition to the diol, the polyester may also be derived from a dicarboxylic acid. For instance, such dicarboxylic acid may be an aliphatic dicarboxylic acid, a dicarboxylic acid, or a mixture thereof. In one embodiment, such dicarboxylic acid may be an aromatic dicarboxylic acid.

The diol is not necessarily limited by the present disclosure. For instance, the diol may be ethylene glycol, 1,4-butanediol, cyclohexane dimethanol (e.g., 1,4-cyclohexanedimethanol), propylene glycol, 1,6-hexanediol, neopentyl glycol, decamethylene glycol, poly(oxy)ethylene glycol, polytetramethylene glycol, polymethylene glycol, or a mixture thereof. In one embodiment, the diol may be ethylene glycol. In another embodiment, the diol may be 1,4-butanediol. In a further embodiment, the diol may be 1,4-cyclohexanedimethanol.

In one embodiment, the diol may be an alkylene glycol. For instance, such a glycol may include, but is not limited to, ethylene glycol, propylene glycol, 1,4-butanediol, or a mixture thereof.

The acid is not necessarily limited by the present disclosure. For instance, the acid may be adipic acid, sebacic acid, succinic acid, oxalic acid, isophthalic acid, terephthalic acid, or a mixture thereof. In one embodiment, the acid may be an aliphatic acid. In this regard, the acid may be adipic acid, sebacic acid, succinic acid, oxalic acid, or a mixture thereof. In one embodiment, the acid may be an aromatic acid. In this regard, the acid may be isophthalic acid, terephthalic acid, or a mixture thereof.

In one embodiment, the acid may be isophthalic acid. In another embodiment, the acid may be terephthalic acid. In a further embodiment, the acid may be a mixture of isophthalic acid and terephthalic acid. In this regard, with respect to the aforementioned aromatic acids, such acid may include at least one aromatic nucleus. However, it should be understood that fuse rings may also be utilized. In this regard, the acid may also include 1,4-, 1,5-, or 2,6-naphthalene-dicarboxylic acid.

The polyester may comprise a polyalkylene terephthalate. While the polyester is not necessarily limited by the present disclosure, the polyester may include, but is not limited to, polyethylene terephthalate, polybutylene terephthalate, and polycyclohexanedimethylene terephthalate, etc. as well as mixtures thereof and copolymers thereof. In one embodiment, the polyester may be polyethylene terephthalate. In another embodiment, the polyester may be polybutylene terephthalate. In a further embodiment, the polyester may be polycyclohexanedimethylene terephthalate.

Related, the polyester may comprise a polyalkylene naphthalate. For instance, the polyester may be polyethylene naphthalate and polybutylene naphthalate, or a mixture thereof. In one embodiment, the polyester may be polyethylene naphthalate. In another embodiment, the polyester may be polybutylene naphthalate.

In addition, the polyester may be synthesized using methods generally known in the art. For instance, the polyester may be synthesized using standard condensation polymerization conditions as generally known in the art.

Regarding the properties of the polyester, it may be desired to have a melt flow that can allow it to be processed in a relatively easy manner for the formation of a polyester composition as well as resulting molded part/article. In this regard, the polyester may exhibit a relatively low melt viscosity as indicated by the melt flow rate. For instance, the melt flow rate of the polyester may be about 0.5 g/10 min or more, such as about 1 g/10 min or more, such as about 2 g/10 min or more, such as about 3 g/10 min or more, such as about 4 g/10 min or more, such as about 5 g/10 min or more, such as about 10 g/10 min or more, such as about 20 g/10 min or more, such as about 30 g/10 min or more, such as about 40 g/10 min or more, such as about 60 g/10 min or more, such as about 80 g/10 min or more. The melt flow rate may be about 100 g/10 min or less, such as about 90 g/10 min or less, such as about 80 g/10 min or less, such as about 70 g/10 min or less, such as about 60 g/10 min or less, such as about 50 g/10 min or less, such as about 40 g/10 min or less, such as about 30 g/10 min or less, such as about 20 g/10 min or less, such as about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO1133.

The polyester may have a certain melting temperature. For instance, the melting temperature may be about 60° C. or more, such as about 80° C. or more, such as about 100° C. or more, such as about 120° C. or more, such as about 140° C. or more, such as about 160° C. or more, such as about 180° C. or more, such as about 200° C. or more, such as about 220° C. or more, such as about 240° C. or more, such as about 260° C. or more, such as about 280° C. or more. The melting temperature may be about 400° C. or less, such as about 380° C. or less, such as about 360° C. or less, such as about 340° C. or less, such as about 320° C. or less, such as about 300° C. or less, such as about 280° C. or less, such as about 250° C. or less, such as about 230° C. or less, such as about 210° C. or less, such as about 200° C. or less, such as about 180° C. or less, such as about 160° C. or less, such as about 140° C. or less, such as about 120° C. or less, such as about 100° C. or less. The melting temperature may be determined using means known in the art, such as differential scanning calorimetry in accordance with ISO 11357-1:2023 at a rate of 10° C./min.

In addition, the glass transition temperature of the polyester, in particular the thermoplastic polyester, may be within a particular range. For instance, the glass transition temperature may be about 0° C. or more, such as about 10° C. or more, such as about 20° C. or more, such as about 30° C. or more, such as about 40° C. or more, such as about 50° C. or more, such as about 60° C. or more, such as about 70° C. or more, such as about 80° C. or more, such as about 90° C. or more, such as about 100° C. or more, such as about 120° C. or more, such as about 140° C. or more, such as about 160° C. or more, such as about 180° C. or more. The glass transition temperature may be about 220° C. or less, such as about 200° C. or less, such as about 190° C. or less, such as about 170° C. or less, such as about 150° C. or less, such as about 130° C. or less, such as about 110° C. or less, such as about 100° C. or less, such as about 90° C. or less, such as about 80° C. or less, such as about 70° C. or less, such as about 60° C. or less. The glass transition temperature may be determined using means known in the art, such as differential scanning calorimetry in accordance with ISO 11357-1:2023 at a rate of 10° C./min.

Further, the polyester may have a particular density. For instance, the density be about 1 g/cm³ or more, such as about 1.1 g/cm³ or more, such as about 1.2 g/cm³ or more, such as about 1.3 g/cm³ or more, such as about 1.4 g/cm³ or more, such as about 1.5 g/cm³ or more, such as about 1.6 g/cm³ or more, such as about 1.7 g/cm³ or more. The polyester may have a density of about 2 g/cm³ or less, such as about 1.9 g/cm³ or less, such as about 1.8 g/cm³ or less, such as about 1.7 g/cm³ or less, such as about 1.6 g/cm³ or less, such as about 1.5 g/cm³ or less, such as about 1.4 g/cm³ or less. The density may be determined in accordance with ISO 1183-1:2019.

Furthermore, it should be understood that a mixture of two or more polyesters, in particular thermoplastic polyesters, can be used. In one embodiment, the composition may contain one polyester as defined herein. In other embodiments, the composition may include a mixture of polyesters. For instance, more than one polyester, such as two or three polyesters, may be utilized in the composition.

The polyester composition may generally comprise about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more, such as about 70 wt. % or more of the polyester (e.g., one or more polyesters) based on the weight of the polyester composition. The polyester composition may comprise about 75 wt. % or less, such as about 70 wt. % or less, such as about 65 wt. % or less, such as about 60 wt. % or less, such as about 55 wt. % or less, such as about 50 wt. % or less of the polyester (e.g., one or more polyesters) based on the weight of the polyester composition. Furthermore, as indicated herein, in one embodiment, the polyester may be present in the polyester composition in an amount sufficient to form a continuous phase or matrix.

### B. Thermoplastic Copolyester Elastomer

As indicated above, the polyester composition includes a thermoplastic copolyester elastomer. For instance, the polyester composition may include one or more thermoplastic copolyester elastomers. The thermoplastic copolyester elastomer may be a thermoplastic copolyetherester elastomer and/or a thermoplastic copolyesterester elastomer. In one embodiment, the thermoplastic copolyester elastomer may be a thermoplastic copolyesterester elastomer. In one particular embodiment, the thermoplastic copolyester elastomer may be a thermoplastic copolyetherester elastomer.

As indicated above, the thermoplastic copolyester elastomer may be a copolyesterester elastomer. In general, a copolyesterester elastomer is a block copolymer containing (a) a hard polyester segment and (b) a soft polyester segment. Examples of hard polyester segments include, but are not limited to, polyalkylene terephthalates, poly(cyclohexanedicarboxylic acid cyclohexanemethanol), etc. and the like. Examples of soft polyester segments include, but are not limited to, aliphatic polyesters including, but not limited to, polybutylene adipate, polytetramethyladipate and polycaprolactone, etc.

The copolyesterester elastomer may contain one or more blocks of ester units of a high melting polyester and one or more blocks of ester units of a low melting polyester which are linked together through ester groups or urethane groups. Copolyesterester elastomers comprising urethane groups may be prepared by reacting the different polyesters in the molten phase, after which the resulting copolyesterester is reacted with a low molecular weight polyisocyanate. The polyisocyanate may be a diisocyanate or a triisocyanate. In particular, the polyisocyanate may be a diisocyanate, such as a paratoluene diisocyanate, diphenylmethane diisocyanate, xylylene diisocyanate, hexamethylene diisocyanate, and/or isophorone diisocyanate.

As indicated above, the thermoplastic copolyester elastomer may be a copolyetherester elastomer. In general, a copolyetherester elastomer may have a multiplicity of recurring long-chain ester units and short-chain ester units joined head-to-tail through ester linkages. The long-chain ester units can be represented by formula (A):

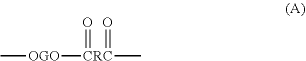

and the short-chain ester units can be represented by formula (B):

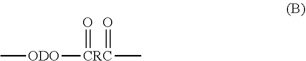

wherein
G is a divalent radical remaining after the removal of the terminal hydroxyl groups from a long chain polymeric glycol having a number average molecular weight of between about 400 and about 6000, preferably between about 400 and about 3000, even more preferably between about 600 and about 3000;
R is a divalent radical remaining after removal of carboxyl groups from a dicarboxylic acid having a number average molecular weight of less than about 300; and
D is a divalent radical remaining after removal of hydroxyl groups from a diol having a number average molecular weight of less than about 250.

As used herein, the term “long-chain ester units” refers to the reaction product of a long-chain glycol with a dicarboxylic acid. The long chain glycols are polymeric glycols having terminal (or nearly terminal as possible) hydroxyl groups. In particular, suitable long-chain glycols include poly(alkylene oxide) glycols having terminal (or as nearly terminal as possible) hydroxyl groups and having a number average molecular weight of from about 400 to about 6000, such as from about 400 to about 3000, such as from about 600 to about 3000, such as from about 1000 to about 3000, such as from about 1000 to about 2000. In addition, the long-chain glycols may have a melting point of less than about 65° C., such as less than about 60° C., such as less than about 55° C., such as less than about 50° C. The long chain glycols are generally poly(alkylene oxide) glycols or glycol esters of poly(alkylene oxide) dicarboxylic acids. Preferred poly(alkylene oxide) glycols include poly(tetramethylene oxide) glycol, poly(trimethylene oxide) glycol, poly(propylene oxide) glycol (e.g., 1,2- or 1,3-propylene oxide), poly(ethylene oxide) glycol, poly(hexamethylene oxide) glycol, poly(heptamethylene oxide) glycol, poly(octamethylene oxide) glycol, poly(nonamethylene oxide) glycol, and poly(1,2-butylene oxide) glycol, copolymer glycols of these alkylene oxides, and block copolymers such as ethylene oxide-capped poly(propylene oxide) glycol. In addition, it should be understood that a mixture of two or more of these glycols may also be utilized. Also, any substituent groups can be present which do not interfere with polymerization of the compound with glycol(s) or dicarboxylic acid(s), as the case may be. The hydroxyl functional groups of the long chain glycols which react to form the copolyester can be terminal groups to the extent possible. The terminal hydroxyl groups can be placed on end capping glycol units different from the chain (e.g., ethylene oxide end groups on poly(propylene oxide glycol). Long chain ester units of Formula (A) may also be referred to as “soft segments” of a copolyetherester elastomer.

As used herein, the term “short-chain ester units” refers to low molecular weight compounds or polymer chain units having a number average molecular weight of less than about 550, such as less than about 525, such as less than about 500, such as less than about 475, such as less than about 450. They can generally be made by reacting a low molecular weight diol or a mixture of diols (molecular weight below about 250, such as below about 225, such as below about 200, such as below about 175, such as below about 150) with a dicarboxylic acid to form ester units represented by Formula (B) above. Short chain ester units of Formula (B) may also be referred to as “hard segments” of the copolyetherester polymer.

Included among the low molecular weight diols which react to form short-chain ester units for preparing copolyesters are acyclic, alicyclic and aromatic dihydroxy compounds. These compounds include diols with about 2 to about 15 carbon atoms, such as about 2 to about 8 carbon atoms, such as about 2 to about 6 carbon atoms, such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. In particular, the diol may be an aliphatic diol, such as 1,4-butanediol, ethylene glycol, 1,3-propanediol, cyclohexanedimethanol, and/or hexamethylene glycol. For instance, the diol may be ethylene glycol, 1,4 butanediol, 1,3-propane diol, or a combination thereof. In particular, the diol may be 1,4 butanediol, 1,3-propane diol, or a combination thereof. In one embodiment, 1,4-butanediol is preferred. In another embodiment, ethylene glycol is preferred. In another further embodiment, 1,3-propanediol is preferred. In one embodiment, 1,4-butanediol may be provided as a mixture with ethylene glycol, 1,3-propanediol, cyclohexanedimethanol, and/or hexamethylene glycol. Included among the bisphenols which can be used are bis(p-hydroxy) diphenyl, bis(p-hydroxyphenyl) methane, and bis(p-hydroxyphenyl) propane. Equivalent ester-forming derivatives of diols are also useful (e.g., ethylene oxide or ethylene carbonate can be used in place of ethylene glycol or resorcinol diacetate can be used in place of resorcinol).

As used herein, the term “diols” includes equivalent ester-forming derivatives such as those mentioned. However, the molecular weight requirements refer to the corresponding diols and not their derivatives.

The dicarboxylic acids that can react with the aforementioned long-chain glycols and low molecular weight diols to produce the copolyetheresters may include aliphatic, cycloaliphatic or aromatic dicarboxylic acids of a low molecular weight (e.g., having a molecular weight of less than about 300, such as less than about 275, such as less than about 250, such as less than about 225). The term “dicarboxylic acids” as used herein includes functional equivalents of dicarboxylic acids that have two carboxyl functional groups that perform substantially like dicarboxylic acids in reaction with glycols and diols in forming thermoplastic copolyetherester elastomers. These equivalents include esters and ester-forming derivatives such as acid halides and anhydrides. The molecular weight requirement pertains to the acid and not to its equivalent ester or ester-forming derivative.

Thus, an ester of a dicarboxylic acid having a molecular weight greater than 300 or a functional equivalent of a dicarboxylic acid having a molecular weight greater than 300 are also suitable, provided the corresponding acid has a molecular weight below about 300 or the aforementioned molecular weights. The dicarboxylic acid can contain any substituent groups or combinations that do not substantially interfere with thermoplastic copolyetherester elastomer formation and use of the thermoplastic copolyetherester elastomer in the composition.

As used herein, the term “aliphatic dicarboxylic acids” refers to carboxylic acids having two carboxyl groups, each attached to a saturated carbon atom. If the carbon atom to which the carboxyl group is attached is saturated and is in a ring, the acid is cycloaliphatic. Aliphatic or cycloaliphatic acids having conjugated unsaturation often may not be used because of homopolymerization. However, some unsaturated acids, such as maleic acid, may be used.

As used herein, the term “aromatic dicarboxylic acids” refers to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—.

Representative aliphatic and cycloaliphatic acids that can be used include, but are not limited to, sebacic acid; 1,3-cyclohexane dicarboxylic acid; 1,4-cyclohexane dicarboxylic acid; adipic acid; glutaric acid; succinic acid; 4-cyclohexane-1,2-dicarboxylic acid; 2-ethylsuberic acid; cyclopentanedicarboxylic acid, decahydro-1,5-naphthylene dicarboxylic acid; 4,4′-bicyclohexyl dicarboxylic acid; decahydro-2,6-naphthylene dicarboxylic acid; 4,4′-methylenebis(cyclohexyl) carboxylic acid; 3,4-furan dicarboxylic acid; and mixtures thereof. In one embodiment, the preferred acid may include a cyclohexane dicarboxylic acid and/or adipic acid.

Representative aromatic dicarboxylic acids that can be used include, but are not limited to, phthalic, terephthalic and isophthalic acids; dibenzoic acid; substituted dicarboxy compounds with two benzene nuclei such as bis(p-carboxyphenyl) methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C₁-C₁₂ alkyl and ring substitution derivatives thereof, such as halo, alkoxy, and aryl derivatives; and mixtures thereof. Hydroxy acids such as p-(beta-hydroxyethoxy)benzoic acid can also be used, provided an aromatic dicarboxylic acid is also used.

In one embodiment, an aromatic dicarboxylic acid is preferred for preparing thermoplastic copolyetherester elastomers. Among the aromatic dicarboxylic acids, those with 8 to 16 carbon atoms, such as 8 to 12 carbon atoms, such as 8 to 10 caron atoms may be preferred. In particular, the aromatic dicarboxylic acid may include terephthalic acid, phthalic acid, and/or isophthalic acid. In particular, the aromatic dicarboxylic acid may include terephthalic acid, isophthalic acid, or a combination thereof. In one embodiment, the aromatic acid may include terephthalic acid alone or with a mixture of phthalic acid and/or isophthalic acid.

When a mixture of two or more dicarboxylic acids is used to prepare the copolyetherester, isophthalic acid may be a preferred second dicarboxylic acid in one embodiment. For instance, isophthalic acid may be provided in a mixture with terephthalic acid. In this regard, the amount of copolymerized isophthalate residues in the copolyetherester may be less than 35 mole %, such as less than 30 mole %, such as less than 25 mole %. Similarly, copolymerized isophthalate residues in the copolyetherester may be less than 35 wt. %, such as less than 30 wt. %, such as less than 25 wt. %, based on the total weight of copolymerized dicarboxylic acid residues —(—C(O)RC(O)—)— in the copolyetherester. The remainder of the phenylene diradicals may be derived from terephthalic acid based on the total number of moles of copolymerized dicarboxylic acid residues —(—C(O)RC(O)—)— in the copolyetherester.

In addition, in one embodiment, at least about 70 mol. % of the groups represented by R in Formulae (A) and (B) above may be 1,4-phenylene radicals and at least about 70 mol. % of the groups represented by D in Formula (B) above may be 1,4-butylene radicals and the sum of the percentages of R groups which are not 1,4-phenylene radicals and D groups which are not 1,4-butylene radicals may not exceed 30 mol. %.

For example, the copolyetherester may have hard segments composed of polybutylene terephthalate and about 5 wt. % to about 80 wt. %, such as about 5 wt. % to about 75 wt. %, such as about 10 wt. % to about 70 wt. %, such as about 10 wt. % to about 60 wt. %, such as about 20 wt. % to about 60 wt. %, of soft segments composed of the reaction product of a polyether glycol and an aromatic diacid. The polyether blocks may be derived from polytetramethylene glycol. Complementarily, the fraction of hard segments may be about 20 wt. % to about 95 wt. %, such as about 20 wt. % to about 90 wt. %, such as about 30 wt. % to about 90 wt. %, such as about 40 wt. % to about 90 wt. %, such as about 40 wt. % to about 80 wt. %.

While not limited, preferred thermoplastic copolyetherester elastomers include those prepared from monomers comprising the following: (A) (1) poly(tetramethylene oxide) glycol, (2) a dicarboxylic acid selected from isophthalic acid, terephthalic acid or a mixture thereof, and (3) a diol selected from 1,4-butanediol, 1,3-propanediol or a mixture thereof; (B) (1) poly(trimethylene oxide) glycol, (2) a dicarboxylic acid selected from isophthalic acid, terephthalic acid or a mixture thereof, and (3) a diol selected from 1,4-butanediol, 1,3-propanediol or a mixture thereof; or (C) (1) ethylene oxide-capped poly(propylene oxide) glycol; (2) a dicarboxylic acid selected from isophthalic acid, terephthalic acid or a mixture thereof; and (3) a diol selected from 1,4-butanediol, 1,3-propanediol or a mixture thereof.

Preferably, the thermoplastic copolyetherester elastomers may be prepared from esters or mixtures of esters of terephthalic acid or isophthalic acid, 1,4-butanediol and poly(tetramethylene ether) glycol, poly(trimethylene ether) glycol, or ethylene oxide-capped polypropylene oxide glycol or may be prepared from esters of terephthalic acid (e.g., dimethylterephthalate), 1,4-butanediol and poly(ethylene oxide) glycol). More preferably, the thermoplastic copolyetherester elastomers may be prepared from esters of terephthalic acid (e.g., dimethylterephthalate), 1,4-butanediol and poly(tetramethylene ether) glycol.

For instance, in one particular embodiment, the thermoplastic copolyetherester elastomer may have the following formula: -[4GT]ₓ-[BT]_{y}-, wherein 4G is the residue of butylene glycol, such as 1,4-butane diol, B is the residue of poly(tetramethylene ether glycol) and T is terephthalate, and wherein x is from about 0.60 to about 0.99 and y is from about 0.01 to about 0.40.

In one aspect, the thermoplastic copolyetherester elastomer can be a block copolymer of polybutylene terephthalate and polyether segments and can have a structure as follows:

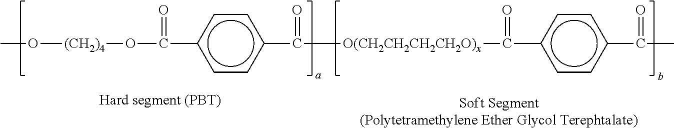

wherein a and b are integers and can vary from 2 to 10,000. The ratio between hard segments and soft segments in the block copolymer as described above can be varied in order to vary the properties of the elastomer.

In general, the thermoplastic copolyetherester elastomer preferably comprises about 1 wt. % or more, such as about 5 wt. % or more, such as about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more of copolymerized residues of long-chain ester units corresponding to Formula (A) above (hard segments). The thermoplastic copolyetherester elastomer preferably comprises about 85 wt. % or less, such as about 80 wt. % or less, such as about 75 wt. % or less, such as about 70 wt. % or less, such as about 65 wt. % or less, such as about 60 wt. % or less of copolymerized residues of long-chain ester units corresponding to Formula (A) above (hard segments).

In general, the thermoplastic copolyetherester elastomer preferably comprises about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more of copolymerized residues of short-chain ester units corresponding to Formula (B) above (soft segments). The thermoplastic copolyetherester elastomer preferably comprises about 99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less of copolymerized residues of short-chain ester units corresponding to Formula (B) above (soft segments).

In one embodiment, the thermoplastic copolyetherester elastomer may comprise only copolymerized residues of long-chain ester units corresponding to Formula (A) above and short-chain ester units corresponding to Formula (B) above. In this regard, the weight percentages of the copolymerized units of Formula (A) and Formula (B) in the copolyetherester may be complementary. That is, the sum of the weight percentages of the copolymerized units of Formula (A) and Formula (B) may be 100 wt. %. Similarly, the mole percentages of the R groups in the copolymerized units of Formula (A) and Formula (B) in the copolyetherester copolymer may be complementary. That is, the sum of the mole percentages of the R groups in the copolymerized units of Formula (A) and Formula (B) may be 100 mol %.

Furthermore, it should be understood that a mixture of two or more thermoplastic copolyester elastomers, in particular thermoplastic copolyetherester elastomers, can be used. In one embodiment, the composition may contain one thermoplastic copolyester elastomer as defined herein. In other embodiments, the composition may include a mixture of thermoplastic copolyester elastomers. For instance, more than one thermoplastic copolyester elastomer, such as two or three thermoplastic copolyester elastomers, may be utilized in the composition.

Specifically, regarding the thermoplastic copolyester elastomers, in particular a mixture of thermoplastic copolyetherester elastomers, each elastomer used need not on an individual basis come within the values set forth above for the elastomers. In this regard, the mixture of two or more thermoplastic copolyetherester elastomers may conform to the values described herein for the copolyetheresters on a weighted average basis, however. For example, in a mixture that contains equal amounts of two thermoplastic copolyetherester elastomers, one thermoplastic copolyetherester elastomer can contain 60 weight percent short-chain ester units and the other resin can contain 30 weight percent short-chain ester units for a weighted average of 45 weight percent short-chain ester units.

Regarding the properties of the thermoplastic copolyester elastomer, it may be desired to have a melt flow that can allow it to be processed in a relatively easy manner for the formation of a composition and resulting part/article as disclosed herein. In this regard, the thermoplastic copolyester elastomer may exhibit a relatively low melt viscosity as indicated by the melt flow rate. For instance, the melt flow rate of the thermoplastic copolyester elastomer may be about 0.5 g/10 min or more, such as about 1 g/10 min or more, such as about 2 g/10 min or more, such as about 3 g/10 min or more, such as about 4 g/10 min or more, such as about 5 g/10 min or more. The melt flow rate may be about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO1133.

The thermoplastic copolyester elastomer may also have a relatively low melting temperature. For instance, the melting temperature may be about 100° C. or more, such as about 110° C. or more, such as about 130° C. or more, such as about 150° C. or more, such as about 170° C. or more, such as about 190° C. or more, such as about 200° C. or more, such as about 220° C. or more, such as about 240° C. or more. The melting temperature may be about 300° C. or less, such as about 280° C. or less, such as about 250° C. or less, such as about 230° C. or less, such as about 210° C. or less, such as about 200° C. or less, such as about 180° C. or less, such as about 160° C. or less, such as about 140° C. or less, such as about 120° C. or less. The melting temperature may be determined using means known in the art, such as differential scanning calorimetry in accordance with ISO 11357-1:2023 at a rate of 10° C./min.

In addition, the glass transition temperature of the thermoplastic copolyester elastomer, in particular the thermoplastic copolyester elastomer, may be within a particular range. For instance, the glass transition temperature may be about −80° C. or more, such as about −70° C. or more, such as about −60° C. or more, such as about −50° C. or more, such as about −40° C. or more, such as about −30° C. or more. The glass transition temperature may be about 0° C. or less, such as about −5° C. or less, such as about −10° C. or less, such as about −20° C. or less, such as about −30° C. or less, such as about −40° C. or less. Also, the glass transition temperature of the hard segment of the thermoplastic copolyester elastomer may be within a particular range. For instance, the glass transition temperature of the hard segment may be about 30° C. or more, such as about 35° C. or more, such as about 40° C. or more, such as about 45° C. or more, such as about 50° C. or more, such as about 55° C. or more, such as about 60° C. or more, such as about 65° C. or more, such as about 70° C. or more, such as about 75° C. or more, such as about 80° C. or more. The glass transition temperature may be about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 55° C. or less, such as about 50° C. or less, such as about 45° C. or less, such as about 40° C. or less, such as about 35° C. or less, such as about 30° C. or less. The glass transition temperature may be determined using means known in the art, such as differential scanning calorimetry in accordance with ISO 11357-1:2023 at a rate of 10° C./min.

Further, the thermoplastic copolyester elastomer may have a particular density. For instance, the density be about 1 g/cm³ or more, such as about 1.03 g/cm³ or more, such as about 1.05 g/cm³ or more, such as about 1.08 g/cm³ or more, such as about 1.1 g/cm³ or more, such as about 1.15 g/cm³ or more, such as about 1.2 g/cm³ or more, such as about 1.3 g/cm³ or more. The thermoplastic copolyester elastomer may have a density of about 2 g/cm³ or less, such as about 1.8 g/cm³ or less, such as about 1.6 g/cm³ or less, such as about 1.4 g/cm³ or less, such as about 1.3 g/cm³ or less, such as about 1.25 g/cm³ or less, such as about 1.2 g/cm³ or less, such as about 1.18 g/cm³ or less, such as about 1.15 g/cm³ or less, such as about 1.12 g/cm³ or less, such as about 1.1 g/cm³ or less. The density may be determined in accordance with ISO 1183-1:2019.

In addition, the thermoplastic copolyester elastomer utilized may exhibit a certain mechanical strength. In particular, the thermoplastic copolyester elastomer may not be as likely to resist deformation in bending compared to other types of materials and as a result, the thermoplastic copolyester elastomer may exhibit a relatively low flexural modulus. For instance, the flexural modulus may be about 300 MPa or less, such as about 260 MPa or less, such as about 220 MPa or less, such as about 200 MPa or less, such as about 190 MPa or less, such as about 180 MPa or less, such as about 170 MPa or less, such as about 160 MPa or less, such as about 150 MPa or less, such as about 140 MPa or less, such as about 130 MPa or less, such as about 120 MPa or less, such as about 110 MPa or less, such as about 100 MPa or less, such as about 90 MPa or less, such as about 80 MPa or less, such as about 70 MPa or less, such as about 60 MPa or less, such as about 50 MPa or less, such as about 40 MPa or less, such as about 30 MPa or less, such as about 20 MPa or less. The flexural modulus may be about 10 MPa or more, such as about 15 MPa or more, such as about 20 MPa or more, such as about 25 MPa or more, such as about 30 MPa or more, such as about 35 MPa or more, such as about 40 MPa or more, such as about 45 MPa or more, such as about 50 MPa or more, such as about 60 MPa or more, such as about 70 MPa or more, such as about 80 MPa or more, such as about 90 MPa or more, such as about 100 MPa or more, such as about 110 MPa or more, such as about 120 MPa or more, such as about 130 MPa or more, such as about 140 MPa or more, such as about 150 MPa or more, such as about 180 MPa or more, such as about 200 MPa or more. The flexural modulus may be determined in accordance with ISO 178:2019 at a temperature of about 23° C.

Relatedly, the thermoplastic copolyester elastomer may have a particular Shore D hardness, which can provide an indication of the resistance to indentation of the thermoplastic copolyester elastomer. In this regard, the Shore D hardness may be about 15 or more, such as about 20 or more, such as about 25 or more, such as about 30 or more, such as about 35 or more, such as about 40 or more, such as about 45 or more, such as about 50 or more. The Shore D hardness may be about 60 or less, such as about 55 or less, such as about 50 or less, such as about 45 or less, such as about 40 or less, such as about 35 or less, such as about 30 or less. Such hardness may allow for the thermoplastic copolyester elastomer to provide the compliance necessary to effectively function for use in a particular application. The Shore D hardness may be determined in accordance with ISO 868-2003 (15 seconds).

In addition, the thermoplastic copolyester elastomer may have other beneficial mechanical properties. For instance, the tensile stress at break may be about 45 MPa or less, such as about 40 MPa or less, such as about 35 MPa or less, such as about 30 MPa or less, such as about 30 MPa or less, such as about 25 MPa or less. The tensile stress at break may be about 5 MPa or more, such as about 10 MPa or more, such as about 15 MPa or more, such as about 20 MPa or more, such as about 25 MPa or more, such as about 30 MPa or more, such as about 35 MPa or more. The tensile stress at break may be determined in accordance with ISO 527-1/-2 (2012) at a temperature of about 23° C.

Also, the thermoplastic copolyester elastomer may have a relatively high nominal strain at break. For instance, the nominal strain at break may be about 500% or more, such as about 550% or more, such as about 600% or more, such as about 650% or more, such as about 700% or more, such as about 750% or more, such as about 800% or more, such as about 850% or more. The nominal strain at break may be about 2000% or less, such as about 1800% or less, such as about 1600% or less, such as about 1400% or less, such as about 1200% or less, such as about 1100% or less, such as about 1000% or less, such as about 950% or less, such as about 900% or less, such as about 850% or less, such as about 800% or less. The nominal strain at break may be determined in accordance with ISO 527-1/-2 (2012) at a temperature of about 23° C.

The polyester composition may generally comprise about 3 wt. % or more, such as about 5 wt. % or more, such as about 8 wt. % or more, such as about 10 wt. % or more, such as about 15 wt. % or more, such as about 20 wt. % or more of the thermoplastic copolyester elastomer based on the weight of the polyester composition. The polyester composition may comprise about 40 wt. % or less, such as about 35 wt. % or less, such as about 30 wt. % or less, such as about 28 wt. % or less, such as about 25 wt. % or less, such as about 22 wt. % or less, such as about 20 wt. % or less, such as about 18 wt. % or less, such as about 16 wt. % or less, such as about 14 wt. % or less, such as about 12 wt. % or less of the thermoplastic copolyester elastomer based on the weight of the polyester composition. Furthermore, as indicated herein, in one embodiment, the thermoplastic copolyester elastomer may be present in the polyester composition in an amount sufficient to form a discontinuous phase such that it is present within the polyester matrix as domains.

### C. Fibrous Filler

As indicated above, the polyester composition includes a fibrous filler. The fibrous filler may have a high degree of tensile strength relative to its mass. For example, the ultimate tensile strength of the fibers (determined in accordance with ASTM D2101) may be from about 1,000 to about 15,000 Megapascals (“MPa”), in some embodiments from about 2,000 MPa to about 10,000 MPa, and in some embodiments from about 3,000 MPa to about 6,000 MPa.

The fibrous filler may be a glass fiber, a ceramic fiber, a carbon fiber, a mineral fiber (e.g., alumina or silica), or a polymer fiber (e.g., aramid, polyolefin, etc.), etc. or a mixture thereof. In one embodiment, the fibrous filler may include glass fibers, mineral fibers, or a mixture thereof. In one particular embodiment, the fibrous filler comprises a glass fiber. The glass fibers particularly suitable may include E-glass, A-glass, C-glass, D-glass, AR-glass, R-glass, S1-glass, S2-glass, etc.

Further, although the fibrous fillers may have a variety of different sizes, fibers having a certain aspect ratio may help improve the mechanical properties of the polyester composition. That is, fibrous fillers having an aspect ratio (average length divided by nominal diameter) of about 2 or more, such as about 5 or more, such as about 10 or more, such as about 25 or more, such as about 50 or more, such as about 75 or more, such as about 100 or more, such as about 150 or more, such as about 200 or more, such as about 250 or more, such as about 300 or more. The aspect ratio may be 500 or less, such as 450 or less, such as 400 or less, such as 350 or less, such as 300 or less, such as 250 or less, such as 200 or less, such as 175 or less, such as 150 or less, such as 125 or less, such as 100 or less, such as 75 or less, such as 50 or less. Such fibrous fillers may, for instance, have a weight average length of about 0.1 mm or more, such as about 0.2 mm or more, such as about 0.5 mm or more, such as about 1 mm or more, such as about 1.5 mm or more, such as about 2 mm or more, such as about 2.5 mm or more, such as about 3 mm or more. The weight average length may be about 10 mm or less, such as about 8 mm or less, such as about 6 mm or less, such as about 5 mm or less, such as about 4.5 mm or less, such as about 4 mm or less, such as about 3.5 mm or less, such as about 3 mm or less, such as about 2.5 mm or less, such as about 2 mm. The fibrous fillers may have an average nominal diameter of about 1 micrometer or more, such as about 2 micrometers or more, such as about 3 micrometers or more, such as about 4 micrometers or more, such as about 5 micrometers or more, such as about 6 micrometers or more, such as about 7 micrometers or more, such as about 8 micrometers or more, such as about 9 micrometers or more, such as about 10 micrometers or more, such as about 11 micrometers or more. The average nominal diameter may be about 30 micrometers or less, such as about 28 micrometers or less, such as about 26 micrometers or less, such as about 24 micrometers or less, such as about 22 micrometers or less, such as about 20 micrometers or less, such as about 18 micrometers or less, such as about 16 micrometers or less, such as about 15 micrometers or less, such as about 14 micrometers or less, such as about 13 micrometers or less, such as about 12 micrometers or less, such as about 11 micrometers or less, such as about 10 micrometers or less.

The fibrous filler may be in a modified or an unmodified form, e.g. provided with a sizing, or chemically treated, in order to improve adhesion. In some examples, glass fibers may be provided with a sizing to protect the glass fiber, to smooth the fiber but also to improve the adhesion between the fiber and a material. If present, a sizing may comprise silanes, film forming agents, lubricants, wetting agents, adhesive agents optionally antistatic agents and plasticizers, emulsifiers and optionally further additives. In one particular embodiment, the sizing may include a silane. Specific examples of silanes are aminosilanes, e.g., 3-trimethoxysilylpropylamine, N-(2-aminoethyl)-3-aminopropyltrimethoxy-silane, N-(3-trimethoxysilanylpropyl) ethane-1,2-diamine, 3-(2-aminoethyl-amino) propyltrimethoxysilane, N-[3-(trimethoxysilyl) propyl]-1,2-ethane-diamine.

If desired, the fibrous filler may be provided into the composition via a masterbatch. For instance, the fibrous filler may be provided with a carrier resin. For example, the carrier resin may enhance the ability of the particles to be handled and incorporated into the polyester composition. While any known carrier resin may be employed for this purpose, in particular embodiments, the carrier resin is a polyester, such as those mentioned above. Further, such polyester as the carrier resin may be the same or different than the polyester employed in the polyester composition, such as the polyester that may form the continuous phase and constitute a majority of the polymer of the polyester composition. If desired, the carrier resin may be pre-blended with the fibrous filler to form a fibrous filler masterbatch, which can later be combined with the polyester and/or the thermoplastic copolyester elastomer. When employed, the carrier resin typically constitutes from about 50 wt. % to about 95 wt. %, in some embodiments from about 60 wt. % to about 85 wt. %, and in some embodiments from about 65 wt. % to about 75 wt. % of the masterbatch, and the fibrous filler typically constitutes from about 5 wt. % to about 50 wt. %, in some embodiments from about 15 wt. % to about 40 wt. %, and in some embodiments from about 25 wt. % to about 35 wt. % of the masterbatch. Of course, other components may also be incorporated into the masterbatch.

The fibrous filler may be present in the polyester composition in an amount of about 1 wt. % or more, such as about 2 wt. % or more, such as about 3 wt. % or more, such as about 5 wt. % or more, 8 wt. % or more, such as about 10 wt. % or more, such as about 12 wt. % or more, such as about 14 wt. % or more, such as about 16 wt. % or more, such as about 18 wt. % or more, such as about 20 wt. % or more, such as about 22 wt. % or more, such as about 24 wt. % or more, such as about 26 wt. % or more, such as about 28 wt. % or more, such as about 30 wt. % or more based on the weight of the polyester composition. The fibrous filler may be present in the polyester composition in an amount of about 40 wt. % or less, such as about 38 wt. % or less, such as about 36 wt. % or less, such as about 35 wt. % or less, such as about 34 wt. % or less, such as about 32 wt. % or less, such as about 30 wt. % or less, such as about 28 wt. % or less, such as about 26 wt. % or less, such as about 24 wt. % or less, such as about 22 wt. % or less, such as about 20 wt. % or less, such as about 18 wt. % or less, such as about 15 wt. % or less, such as about 12 wt. % or less, such as about 10 wt. % or less, such as about 8 wt. % or less, such as about 6 wt. % or less based on the weight of the polyester composition.

### D. Olefin Acrylic Acid Copolymer

In one embodiment, the polyester composition may include an olefin copolymer, in particular an olefin acrylic acid copolymer. For instance, the olefin copolymer, such as the olefin acrylic acid copolymer, may be formed from one or more of ethylene and higher alpha-olefins, which may include, but are not limited to propylene, 1-butene, 1-hexene, 4-methyl-1 pentene, 1-octene, 1-decene, or combinations thereof, and may include one or more copolymerizable, multiply unsaturated comonomers. Such comonomers may include an acid, such as acrylic acid, methacrylic acid, or a mixture thereof. In one embodiment, such comonomer may include acrylic acid. In one embodiment, such comonomer may include methacrylic acid. In one embodiment, such olefin acrylic acid copolymer may be an ethylene acrylic acid copolymer. In another embodiment, the olefin acrylic acid copolymer may be an ethylene methacrylic acid copolymer.

Furthermore, in one embodiment, such copolymer may be at least partially neutralized. For instance, such copolymer may be at least partially neutralized with a metallic cation. Such metallic cation may include, but is not limited to, sodium, calcium, zinc, lithium, potassium, etc. In one embodiment, such metallic cation may include sodium.

In this regard, in one embodiment, such olefin acrylic acid copolymer may be referred to as an ionomer. Such ionomers may include, but are not limited to, ethylene-acrylic acid sodium salt copolymer, ethylene-acrylic acid potassium salt copolymer, ethylene-acrylic acid potassium zinc copolymer, ethylene-acrylic acid calcium salt copolymer, ethylene-methacrylic acid sodium salt copolymer, ethylene-methacrylic acid potassium salt copolymer, ethylene-methacrylic acid zinc salt copolymer, ethylene-methacrylic acid calcium salt copolymer. In one embodiment, the copolymer may include an ethylene-acrylic acid sodium salt copolymer. In another embodiment, the copolymer may include an ethylene-methacrylic acid sodium salt copolymer.

The ionomer may have a melt flow rate of from 0.1 g/10 min to 14 g/10 min, such as from 0.1 g/10 min to 10 g/10 min, such as from 0.1 g/10 min to 5 g/10 min, such as from 0.1 g/10 min to 3 g/10 min, such as from 0.5 g/10 min to 1.5 g/10 min at 190° C. under a load of 2.16 kg and a density of 0.93 g/cm³ to 0.97 g/cm³ at 25° C. The melt flow rate may be measured according to standard ASTM D792 and the density may be measured according to standard ASTM D1238. In addition, the ionomer may have a melting point of from 84° C. to 101° C. and a Vicat softening point of from 40° C. to 81° C. The melting point may be obtained according to the method of standard ASTM D3418 and the Vicat softening point may be measured according to standard ASTM D1525.

When utilized, the olefin acrylic acid copolymer may be present in the polyester composition in an amount of about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 5 wt. % or more based on the weight of the polyester composition. The olefin acrylic acid copolymer may be present in the polyester composition in an amount of about 10 wt. % or less, such as about 8 wt. % or less, such as about 6 wt. % or less, such as about 5 wt. % or less, such as about 4.5 wt. % or less, such as about 4 wt. % or less, such as about 3.5 wt. % or less, such as about 3 wt. % or less, such as about 2.8 wt. % or less, such as about 2.5 wt. % or less, such as about 2.3 wt. % or less, such as about 2 wt. % or less, such as about 1.8 wt. % or less, such as about 1.5 wt. % or less, such as about 1.2 wt. % or less, such as about 1 wt. % or less, such as about 0.8 wt. % or less based on the weight of the polyester composition.

### E. Epoxy Resin

In one embodiment, the polyester composition may include a resin, such as an epoxy resin. The epoxy resin may have a certain epoxy equivalent. Namely, the epoxy equivalent weight may generally be from about 250 to about 1,500, in some embodiments from about 400 to about 1,000, and in some embodiments, from about 500 to about 800 grams per gram equivalent as determined in accordance with ASTM D1652-11e1. The epoxy resin may typically contain, on the average, at least about 1.3, in some embodiments from about 1.6 to about 8, and in some embodiments, from about 3 to about 5 epoxide groups per molecule. The epoxy resin may also typically have a relatively low dynamic viscosity, such as from about 1 centipoise to about 25 centipoise, in some embodiments 2 centipoise to about 20 centipoise, and in some embodiments, from about 5 centipoise to about 15 centipoise, as determined in accordance with ASTM D445-15 at a temperature of 25° C. At room temperature (25° C.), the epoxy resin may also typically be a solid or semi-solid material having a melting point of from about 50° C. to about 120° C., in some embodiments from about 60° C. to about 110° C., and in some embodiments, from about 70° C. to about 100° C.

The epoxy resin can be saturated or unsaturated, linear or branched, aliphatic, cycloaliphatic, aromatic or heterocyclic, and may bear substituents which do not materially interfere with the reaction with the oxirane. Suitable epoxy resins include, for instance, glycidyl ethers (e.g., diglycidyl ether) that are prepared by reacting an epichlorohydrin with a hydroxyl compound containing at least 1.5 aromatic hydroxyl groups, optionally under alkaline reaction conditions. Multi-functional compounds are particularly suitable. For instance, the epoxy resin may be a diglycidyl ether of a dihydric phenol, diglycidyl ether of a hydrogenated dihydric phenol, triglycidyl ether of a trihydric phenol, triglycidyl ether of a hydrogenated trihydric phenol, etc. Diglycidyl ethers of dihydric phenols may be formed, for example, by reacting an epihalohydrin with a dihydric phenol. Examples of suitable dihydric phenols include, for instance, 2,2-bis(4-hydroxyphenyl) propane (“bisphenol A”); 2,2-bis 4-hydroxy-3-tert-butylphenyl) propane; 1,1-bis(4-hydroxyphenyl) ethane; 1,1-bis(4-hydroxyphenyl) isobutane; bis(2-hydroxy-1-naphthyl) methane; 1,5 dihydroxynaphthalene; 1,1-bis(4-hydroxy-3-alkylphenyl) ethane, etc. Suitable dihydric phenols can also be obtained from the reaction of phenol with aldehydes, such as formaldehyde) (“bisphenol F”). Commercially available examples of such multi-functional epoxy resins may include Epon™ resins available from Hexion under the designations 862, 828, 826, 825, 1001, 1002, 1009, SU3, 154, 1031, 1050, 133, and 165. Other suitable multi-functional epoxy resins are available from Huntsman under the trade designation Araldite™ (e.g., Araldite™ ECN 1273 and Araldite™ ECN 1299.

When utilized, the epoxy resin may be present in the polyester composition in an amount of about 0.01 wt. % or more, such as about 0.05 wt. % or more, such as about 0.1 wt. % or more, such as about 0.2 wt. % or more, such as about 0.3 wt. % or more, such as about 0.4 wt. % or more such as about 0.5 wt. % or more, such as about 0.6 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 5 wt. % or more based on the weight of the polyester composition. The epoxy resin may be present in the polyester composition in an amount of about 10 wt. % or less, such as about 8 wt. % or less, such as about 6 wt. % or less, such as about 5 wt. % or less, such as about 4 wt. % or less, such as about 3 wt. % or less, such as about 2.8 wt. % or less, such as about 2.5 wt. % or less, such as about 2.3 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.8 wt. % or less, such as about 0.5 wt. % or less based on the weight of the polyester composition.

### F. Additives

In addition to the polyester, the thermoplastic copolyester elastomer, and the fibrous filler, and any other optional additives as mentioned above, the polyester composition may optionally further comprise one or more additives, such as those mentioned below. In this regard, in one embodiment, the polyester composition may further comprise one or more additives. For instance, the additives may include those typically utilized in the art in order to provide a resulting composition or material having the desired properties. These additives may include, but are not limited to, fillers, reinforcing agents, process aids, plasticizers, stabilizers (e.g., heat stabilizers; UV light stabilizers; metal deactivators; antioxidants such as phenolic, phosphite, and/or amine containing antioxidants; etc.), viscosity modifiers, nucleating agents, lubricants, flow enhancing additives, flame retardants (e.g., phosphates such as polyphosphates, pyrophosphates, etc.; phosphinates; etc.), impact modifiers, antistatic agents, antimicrobial agents, colorants, pigments, etc.

In one embodiment, the polyester composition may include one or more antioxidants. For instance, the polyester composition may include a phenolic antioxidant, a phosphite antioxidant, an amine antioxidant, or a mixture thereof. In one embodiment, the polyester composition may include a phenolic antioxidant, a phosphite antioxidant, or a mixture thereof. For instance, the polyester composition may include a phenolic antioxidant in one embodiment. In another embodiment, the polyester composition may include a phosphite antioxidant. In a particular embodiment, the polyester composition may include a mixture of a phenolic antioxidant and a phosphite antioxidant.

The phenolic antioxidant may be a sterically hindered phenolic antioxidant. Examples of such phenolic antioxidants include, for instance, calcium bis(ethyl 3,5-di-tert-butyl-4-hydroxybenzylphosphonate) (Irganox® 1425); terephthalic acid, 1,4-dithio-, S,S-bis(4-tert-butyl-3-hydroxy-2,6-dimethylbenzyl) ester (Cyanox®1729); triethylene glycol bis(3-tert-butyl-4-hydroxy-5-methylhydrocinnamate); hexamethylene bis(3,5-di-tert-butyl-4-hydroxyhydrocinnamate (Irganox®259); 1,2-bis(3,5,di-tert-butyl-4-hydroxyhydrocinnamoyl) hydrazide (Irganox®1024); 4,4′-di-tert-octyldiphenamine (Naugalube®438R); phosphonic acid, (3,5-di-tert-butyl-4-hydroxybenzyl)-, dioctadecyl ester (Irganox® 1093); 1,3,5-trimethyl-2,4,6-tris(3′,5′-di-tert-butyl-4′ hydroxybenzyl)benzene (Irganox®1330); 2,4-bis(octylthio)-6-(4-hydroxy-3,5-di-tert-butylanilino)-1,3,5-triazine (Irganox®565); isooctyl 3-(3,5-di-tert-butyl-4-hydroxyphenyl) propionate (Irganox® 1135); octadecyl 3-(3,5-di-tert-butyl-4-hydroxyphenyl) propionate (Irganox® 1076); 3,7-bis(1,1,3,3-tetramethylbutyl)-10H-phenothiazine (Irganox® LO 3); 2,2′-methylenebis(4-methyl-6-tert-butylphenol) monoacrylate (Irganox® 3052); 2-tert-butyl-6-[1-(3-tert-butyl-2-hydroxy-5-methylphenyl)ethyl]-4-methylphenyl acrylate (Sumilizer®TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox®1520); N,N′-trimethylenebis-[3-(3,5-di-tert-butyl-4-hydroxyphenyl) propionamide (Irganox®1019); 4-n-octadecyloxy-2,6-diphenylphenol (Irganox® 1063); 2,2′-ethylidenebis[4,6-di-tert-butylphenol](Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl) propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl) propionate] (Irganox® 1010); ethylene-bis(oxyethylene) bis[3-(5-tert-butyl-4-hydroxy-m-tolyl)-propionate (Irganox® 245); 3,5-di-tert-butyl-4-hydroxytoluene (Lowinox BHT) and so forth. In one embodiment, for instance, the phenolic antioxidant comprises pentaerythrityl tetrakis[3-(3,5-di-tert-butyl-4-hydroxyphenyl) propionate].

The phosphite antioxidant may include, for instance, a monophosphite, a diphosphite, or a mixture thereof. In particular, the phosphite antioxidants may include aryl monophosphites, aryl diphosphites, or a mixture thereof. In one particular embodiment, the phosphite may include a diphosphite, such as an aryl diphosphite.

The monophosphites may include aryl monophosphites containing C₁ to C₁₀ alkyl substituents on at least one of the aryloxide groups. These substituents may be linear (as in the case of nonyl substituents) or branched (such as isopropyl or tertiary butyl substituents). Non-limiting examples of suitable aryl monophosphites may include triphenyl phosphite; diphenyl alkyl phosphites; phenyl dialkyl phosphites; tris(nonylphenyl) phosphite; tris(2,4-di-tert-butylphenyl) phosphite (Irgafos® 168); bis(2,4-di-tert-butyl-6-methylphenyl)ethyl phosphite (Irgafos® 38); and 2,2′,2″-nitrilo[triethyltris(3,3′5,5″-tetra-tert-butyl-1,1′-biphenyl-2,2′-diyl) phosphate (Irgafos® 12). Aryl diphosphites or diphosphonites (i.e., contains at least two phosphorus atoms per phosphite molecule) may include, for instance; distearyl pentaerythritol diphosphite, diisodecyl pentaerythritol diphosphite, bis (2,4 di-tert-butylphenyl) pentaerythritol diphosphite (Irgafos 126); bis(2,6-di-tert-butyl-4-methylpenyl) pentaerythritol diphosphite; bisisodecyloxypentaerythritol diphosphite, bis(2,4-di-tert-butyl-6-methylphenyl) pentaerythritol diphosphite, bis(2,4,6-tri-tert-butylphenyl) pentaerythritol diphosphite, tetrakis(2,4-di-tert-butylphenyl) 4,4′-biphenylene-diphosphonite (Sandostab™ P-EPQ) and bis(2,4-dicumylphenyl) pentaerythritol diphosphite (Doverphos® S-9228). In one embodiment, the phosphite antioxidant may include bis (2,4 di-tert-butylphenyl) pentaerythritol diphosphite. It should be understood that the polyester composition may also include any combination of the aforementioned.

In one embodiment, the polyester composition may include a lubricant. For example, the lubricant may include a polyolefin wax (e.g., polyethylene wax), an amide wax, a fatty acid ester wax, etc. In one embodiment, the lubricant may include a polyolefin wax, such as a polyethylene wax. In one particular embodiment, the lubricant may include an oxidized polyolefin wax, such as an oxidized polyethylene wax. The polyolefin wax may have a relatively high density. For instance, the density may be 0.90 g/cm³ or more, such as 0.91 g/cm³ or more, such as 0.92 g/cm³ or more, such as 0.93 g/cm³ or more, such as 0.94 g/cm³ or more. The density may be 0.99 g/cm³ or less, such as 0.98 g/cm³ or less, such as 0.97 g/cm³ or less, such as 0.96 g/cm³ or less.

The lubricant may also be a fatty acid ester wax. Fatty acid ester waxes may, for instance, be obtained by oxidative bleaching of a crude natural wax and subsequent esterification of the fatty acids with an alcohol. The alcohol may, in some cases, have 1 to 4 hydroxyl groups and 2 to 20 carbon atoms. When the alcohol is multifunctional (e.g., 2 to 4 hydroxyl groups), a carbon atom number of 2 to 8 is particularly desired. Particularly suitable multifunctional alcohols may include dihydric alcohol (e.g., ethylene glycol, propylene glycol, butylene glycol, 1,3-propanediol, 1,4-butanediol, 1,6-hexanediol and 1,4-cyclohexanediol), trihydric alcohol (e.g., glycerol and trimethylolpropane), tetrahydric alcohols (e.g., pentaerythritol and erythritol), and so forth. Aromatic alcohols may also be suitable, such as o-, m- and p-tolylcarbinol, chlorobenzyl alcohol, bromobenzyl alcohol, 2,4-dimethylbenzyl alcohol, 3,5-dimethylbenzyl alcohol, 2,3,5-cumobenzyl alcohol, 3,4,5-trimethylbenzyl alcohol, p-cuminyl alcohol, 1,2-phthalyl alcohol, 1,3-bis(hydroxymethyl)benzene, 1,4-bis(hydroxymethyl)benzene, pseudocumenyl glycol, mesitylene glycol and mesitylene glycerol. Particularly suitable fatty acid esters for use may be derived from montanic waxes. Such waxes may be partially esterified with butylene glycol and/or partially saponified with calcium hydroxide. In one embodiment, such waxes may include a mixture of montanic acid esters and calcium montanate.

In one embodiment, the polyester composition may include a plasticizer. Suitable plasticizers for use herein may be selected from polyols or esters thereof, polyester ethers, polyesters, polyethers, ester terminated polybutylene adipates, sulfonamides, benzoates, etc. and mixtures thereof. Specific plasticizers may include, but are not limited to, 2,2-dimethylpropane diol 1,3-dibenzoate, polyethylene glycol esters (e.g., polyethylene glycol dilaurate), polyalkylene adipates, etc. In one embodiment, the plasticizer may include a polyol, such as a glycol, or an ester thereof. For instance, the plasticizer may include a polyol ester, such as a glycol ester, such as a polyethylene glycol ester.

In one embodiment, the polyester composition may include a black pigment. The black pigment may generally include carbon black which may be provided as a plurality of carbon black particles, such as furnace black, channel black, acetylene black, lamp black, etc. The carbon black particles may have any desired shape, such as a granular, flake (scaly), etc. The average size (e.g., diameter) of the particles may, for instance, range from about 1 to about 200 nanometers, in some embodiments from about 5 to about 150 nanometers, and in some embodiments from about 10 to about 100 nanometers. It is also typically desired that the carbon black particles are relatively pure, such as containing polynuclear aromatic hydrocarbons (e.g., benzo[a] pyrene, naphthalene, etc.) in an amount of about 1 part per million (“ppm”) or less, and in some embodiments about 0.5 ppm or less. For example, the black pigment may contain benzo[a] pyrene in an amount of about 10 parts per billion (“ppb”) or less, and in some embodiments about 5 ppb or less.

If desired, the black pigment, such as the carbon black, of the polyester composition may include a carrier resin that can encapsulate the carbon black particles, thereby providing a variety of benefits. For example, the carrier resin can enhance the ability of the particles to be handled and incorporated into the base polyester composition. While any known carrier resin may be employed for this purpose, in particular embodiments, the carrier resin is a polyester, such as those mentioned above. Further, such polyester as the carrier resin may be the same or different than the polyester employed in the polyester composition, such as the polyester that may form the continuous phase and constitute a majority of the polymer of the polyester composition. If desired, the carrier resin may be pre-blended with the carbon black particles to form a pigment masterbatch, which can later be combined with the polyester and/or the thermoplastic copolyester elastomer. When employed, the carrier resin typically constitutes from about 50 wt. % to about 95 wt. %, in some embodiments from about 60 wt. % to about 90 wt. %, and in some embodiments from about 70 wt. % to about 85 wt. % of the masterbatch, and the carbon black particles typically constitute from about 5 wt. % to about 50 wt. %, in some embodiments from about 10 wt. % to about 40 wt. %, and in some embodiments from about 15 wt. % to about 30 wt. % of the masterbatch. Of course, other components may also be incorporated into the masterbatch.

When utilized, the respective additive may be present in the polyester composition in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 5 wt. % or more, 8 wt. % or more, such as about 10 wt. % or more, such as about 12 wt. % or more, such as about 14 wt. % or more based on the weight of the polyester composition. The respective additive may be present in the polyester composition in an amount of about 15 wt. % or less, such as about 12 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2.8 wt. % or less, such as about 2.5 wt. % or less, such as about 2.3 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.8 wt. % or less, such as about 0.5 wt. % or less based on the weight of the polyester composition.

### II. Composition Formation

The polyester composition described herein can be processed using techniques generally known in the art. For instance, the components (polyester, thermoplastic copolyester elastomer, fibrous filler, and other optional additives) may be melt-mixed (also referred to as melt-blended). Utilizing such an approach, the components may be well-dispersed throughout the composition. Furthermore, the components may be provided in a single-step addition or in a step-wise manner. The processing may be conducted in a chamber, which may be any vessel that is suitable for blending the composition under the necessary temperature and shearing force conditions. In this respect, the chamber may be a mixer, such as a Banbury™ mixer or a Brabender™ mixer, an extruder, such as a co-rotating extruder, a counter-rotating extruder, or a twin-screw extruder, a co-kneader, such as a Buss® kneader, etc. The melt blending may be carried out at a temperature ranging from 150 to 300° C., such as from 200 to 280° C., such as from 220 to 270° C. or 240 to 260° C. However, such processing should be conducted for each respective composition at a desired temperature to minimize any polymer degradation. Upon completion of the mixing/blending, the composition may be milled, chopped, extruded, pelletized, or processed by any other desirable technique. In certain instances, the components may be melt-blended and directly fed to a downstream operation or molding apparatus for formation of a resulting molded part or article.

In one embodiment, the blending may be conducted in an extruder. In this regard, one or more of the aforementioned components of the polyester composition may be provided as a side feed to the extruder rather than the back of the extruder, which is generally the end opposite the die/nozzle of the extruder. Such side feed is generally downstream from the back of the extruder and between the back of the extruder near the hopper and the die/nozzle of the extruder. For instance, the back of the extruder may be where a hopper is generally located and the side feed may be downstream from such hopper. In one embodiment, the thermoplastic copolyester elastomer may be provided in a side feed to the extruder. In one embodiment, the fibrous filler may be provided in a side feed to the extruder. In a further embodiment, the thermoplastic copolyester elastomer and the fibrous filler may be provided in a side feed to the extruder. In other embodiments, the thermoplastic copolyester elastomer and/or fibrous filler may be provided at the back of the extruder. In one embodiment, the polyester may be provided at the back of the extruder, such as through a hopper or feed device. In one embodiment, the feed of the fibrous filler to the extruder may be in a fibrous filler masterbatch, particularly one wherein the carrier resin is a polyester.

In one embodiment, the polyester composition may be cube blended. That is, the components may be blended, such as in a molding apparatus, using one or more masterbatches of material. For example, a fibrous filler masterbatch, particularly one wherein the carrier resin is a polyester, may be blended with the thermoplastic copolyester elastomer. In addition, the polyester, not in a masterbatch form, may also be blended in the molding apparatus. Such molding apparatus may be one as described herein, such as an injection molded apparatus. Such cube blending may differ from other forms of blending in that cube blending may be utilized to immediately form a molded part without having to reheat/remelt the composition. Meanwhile, using other traditional techniques wherein the polyester composition is pelletized, the composition may then have to undergo a subsequent heating/melting process to form a molded part.

In other words, the method may include a step of mixing pellets (e.g., fibrous filler masterbatch, thermoplastic copolyester elastomer, and/or polyester) with each other, particularly in a predetermined ratio, melting such pellets in a molding apparatus, and molding the obtained pellet mixture/melt mixture into a molded part. In this regard, one or more of such components or pellets may be fed directly to a molding apparatus.

### III. Molded Parts

As indicated herein, the polyester composition is suitable for forming molded parts and articles. In this regard, the polyester composition may be molded into a molded part/article using conventional molding apparatuses and techniques, such as injection molding, extrusion molding, compression molding, blow molding, rotational molding, overmolding, thermoforming, etc. In general, these processes include heating the polyester composition to a temperature that is equal to or in excess of the melt temperature to form a pre-form for a mold cavity to then form the molded part, cooling the molded part to a temperature at or below the crystallization temperature, and releasing the molded part/article from a mold. The mold cavity defines the shape of the molded part/article. The molded part/article is cooled within the mold at a temperature at or below the crystallization temperature and the molded part/article can subsequently be released from the mold. The process may also utilize extrusion molding. In this regard, the polyester composition may be extruded as described herein. Upon exiting the extruder, the polyester composition may be formed or shaped to a desired part/article. Such part/article may be formed by using a particular die to shape the polyester composition as it exits the extruder. Such shaping/forming process, such as the extrusion process, may be an automated or robotic process.

The polyester composition as disclosed herein may be utilized in a variety of applications. For instance, the polyester composition may be suitable for an automotive part, an electronic part, a consumer goods article, a medical article, among others. In particular, the polyester composition may be utilized for chain saw parts, bicycle wheels, fasteners, furniture parts, sports equipment, etc.

### EXAMPLES

### Example 1

The polyester compositions of samples 1-9 are summarized in the table below. For these compositions, the thermoplastic copolyester elastomer was fed in the back of the extruder along with polyethylene terephthalate and other additives. Meanwhile, glass fiber was fed from the side barrel of the extruder. The compounding was done using a Coperion ZSK-MC-26 mm twin screw corotating extruder with 14 barrels wherein the process section utilized had an L/d of 39:1.

| | 1 | 2 | 3 | 4 | 5 | 6 | 7 | 8 | 9 |
|---|---|---|---|---|---|---|---|---|---|
| Glass fibers | 30 | 30 | 30 | 30 | 30 | 30 | 30 | 30 | 30 |
| (wt. %) | | | | | | | | | |
| Plasticizer | 2.76 | 2.76 | 2.76 | 2.76 | 2.76 | 2.76 | 2.76 | 2.76 | 2.76 |
| (wt. %) | | | | | | | | | |
| Polyethylene | 47.89 | 47.89 | 47.89 | 47.89 | 47.89 | 47.89 | 47.89 | 47.89 | 47.89 |
| terephthalate | | | | | | | | | |
| (wt. %) | | | | | | | | | |
| Ionomer of | 3.42 | 3.42 | 3.42 | 3.42 | 3.42 | 3.42 | 3.42 | 3.42 | 3.42 |
| ethylene acid | | | | | | | | | |
| copolymer | | | | | | | | | |
| (wt. %) | | | | | | | | | |
| Thermoplastic | 13 | 13 | 13 | — | — | — | — | — | — |
| copolyester | | | | | | | | | |
| elastomer | | | | | | | | | |
| (42 Shore D) | | | | | | | | | |
| (wt. %) | | | | | | | | | |
| Thermoplastic | — | — | — | 13 | 13 | 13 | — | — | — |
| copolyester | | | | | | | | | |
| elastomer | | | | | | | | | |
| (33 Shore D) | | | | | | | | | |
| (wt. %) | | | | | | | | | |
| Thermoplastic | — | — | — | — | — | — | 13 | 13 | 13 |
| copolyester | | | | | | | | | |
| elastomer | | | | | | | | | |
| (26 Shore D) | | | | | | | | | |
| (wt. %) | | | | | | | | | |
| Epoxy resin | 0.6 | 0.6 | 0.6 | 0.6 | 0.6 | 0.6 | 0.6 | 0.6 | 0.6 |
| (wt. %) | | | | | | | | | |
| Phenolic | 0.26 | 0.26 | 0.26 | 0.26 | 0.26 | 0.26 | 0.26 | 0.26 | 0.26 |
| antioxidant | | | | | | | | | |
| (wt. %) | | | | | | | | | |
| Lubricant | 0.9 | 0.9 | 0.9 | 0.9 | 0.9 | 0.9 | 0.9 | 0.9 | 0.9 |
| (wt. %) | | | | | | | | | |
| Carbon black | 1.17 | 1.17 | 1.17 | 1.17 | 1.17 | 1.17 | 1.17 | 1.17 | 1.17 |
| (30 wt. %) | | | | | | | | | |
| masterbatch in | | | | | | | | | |
| polyethylene | | | | | | | | | |
| terephthalate | | | | | | | | | |
| (wt. %) | | | | | | | | | |

Screw RPM and properties for Examples 1-9 are summarized in table below. It was found that these samples appeared to have dispersions of the thermoplastic copolyester elastomer of up to about 2 micrometers in size.

| | 1 | 2 | 3 | 4 | 5 | 6 | 7 | 8 | 9 |
|---|---|---|---|---|---|---|---|---|---|
| RPM | 200 | 250 | 300 | 200 | 250 | 300 | 200 | 250.0 | 300.0 |
| Izod Notched | 9.4 | 8.0 | 8.0 | 8.6 | 8.5 | 8.2 | 9.3 | 8.6 | 8.7 |
| Impact Strength | | | | | | | | | |
| (kJ/m²) | | | | | | | | | |
| Tensile | 72 | 66 | 63 | 58 | 58 | 58 | 60 | 58 | 56 |
| Strength | | | | | | | | | |
| (MPa) | | | | | | | | | |
| Tensile | 1.07 | 1.03 | 0.98 | 0.97 | 1.00 | 1.07 | 1.18 | 1.22 | 1.22 |
| Elongation | | | | | | | | | |
| (%) | | | | | | | | | |
| Tensile | 8621 | 8533 | 8250 | 7906 | 7826 | 7795 | 7412 | 7212 | 7220 |
| Modulus | | | | | | | | | |
| (MPa) | | | | | | | | | |

### Example 2

The polyester compositions of samples 10-12 are summarized in the table below. For these compositions, the thermoplastic copolyester elastomer and glass fibers were fed from the side barrel of the extruder and the polyethylene terephthalate and other additives were fed in the back of the extruder. Meanwhile, glass fiber was fed from a side barrel. The compounding was done using a Coperion ZSK-MC-26 mm twin screw corotating extruder with 14 barrels wherein the process section utilized had an L/d of 39:1.

| | 10 | 11 | 12 |
|---|---|---|---|
| Glass fibers (wt. %) | 30 | 30 | 30 |
| Plasticizer (wt. %) | 2.76 | 2.76 | 2.76 |
| Polyethylene terephthalate | 51.96 | 48.96 | 46.96 |
| (wt. %) | | | |
| Ionomer of ethylene acid | 3.42 | 3.42 | 3.42 |
| copolymer (wt. %) | | | |
| Thermoplastic copolyester | 10 | 13 | 15 |
| elastomer | | | |
| (33 Shore D) (wt. %) | | | |
| Epoxy resin (wt. %) | 0.6 | 0.6 | 0.6 |
| Phenolic antioxidant (wt. %) | 0.16 | 0.16 | 0.16 |
| Lubricant (wt. %) | 0.9 | 0.9 | 0.9 |
| Phosphite antioxidant (wt. %) | 0.2 | 0.2 | 0.2 |
| Izod Notched Impact Strength | 13.6 | 14.7 | 14.7 |
| (kJ/m²) | | | |
| Tensile Strength (MPa) | 122 | 111 | 107 |
| Tensile Elongation (%) | 2.79 | 2.76 | 2.66 |
| Tensile Modulus (MPa) | 9845 | 9453 | 9162 |

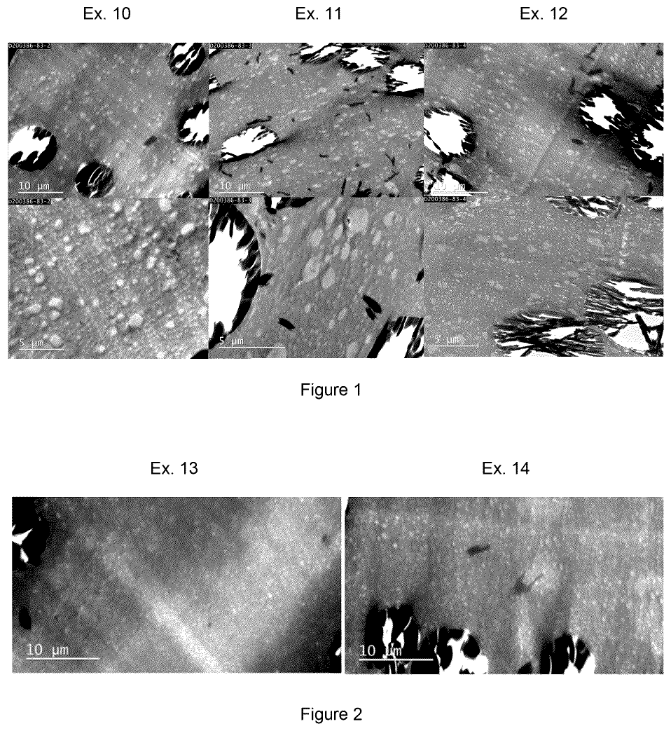

TEM images, as illustrated in FIG. 1, for samples 10-12 with 10 wt. %-15 wt. % thermoplastic copolyester elastomer appear to indicate good dispersion (˜1 micrometer). For these samples, it appears that dispersion of thermoplastic copolyester elastomer improves as indicated by a greater number of smaller inclusions of thermoplastic copolyester elastomer within the polyester matrix as the weight percentage of thermoplastic copolyester elastomer increases from 10 wt. % to 15 wt. %.

### Example 3

The polyester compositions of samples 13-14 are summarized in the table below. For these compositions, cube blending was utilized wherein pellets of 30% glass reinforced polyethylene terephthalate and thermoplastic copolyester elastomer pellets were fed to an injection molding process.

| | 13 | 14 |
|---|---|---|
| Polyethylene terephthalate | 64.4% | 60.9% |
| (wt. %) | | |
| Glass fibers (wt. %) | 27.6% | 26.1% |
| Thermoplastic copolyester | 8% | 13% |
| elastomer | | |
| (33 Shore D) (wt. %) | | |
| Izod Notched Impact Strength | 14.5 | 14.6 |
| (kJ/m²) | | |
| Tensile Strength (MPa) | 114 | 108 |
| Tensile Elongation (%) | 2.6 | 3.4 |
| Tensile Modulus (MPa) | 8608 | 7855 |

TEM images, as illustrated in FIG. 2, for samples 13 and 14 appear to indicate improved dispersion of the thermoplastic copolyester elastomer compared to samples 10-12. In particular, the domains of the thermoplastic copolyester elastomer appear to be sub-micrometer.

### Example 4

The polyester compositions of samples 15-16 are summarized in the table below. For sample 15, cube blending was utilized wherein pellets of 30% glass reinforced polyethylene terephthalate and thermoplastic copolyester elastomer pellets were fed to an injection molding process. For sample 16, the composition was prepared according to the process of samples 10-12.

| | 15 | 16 |
|---|---|---|
| Polyethylene terephthalate | 61% | 61% |
| (wt. %) | | |
| Glass fibers (wt. %) | 26% | 26% |
| Thermoplastic copolyester | 13% | 13% |
| elastomer (wt. %) | | |
| (26 Shore D) | | |
| Notched Impact (kJ/m²) | 15.3 | 14.4 |
| Tensile Strength (MPa) | 108 | 98 |
| Tensile Elongation (%) | 3.1 | 2.9 |
| Tensile Modulus (MPa) | 7933 | 7506 |

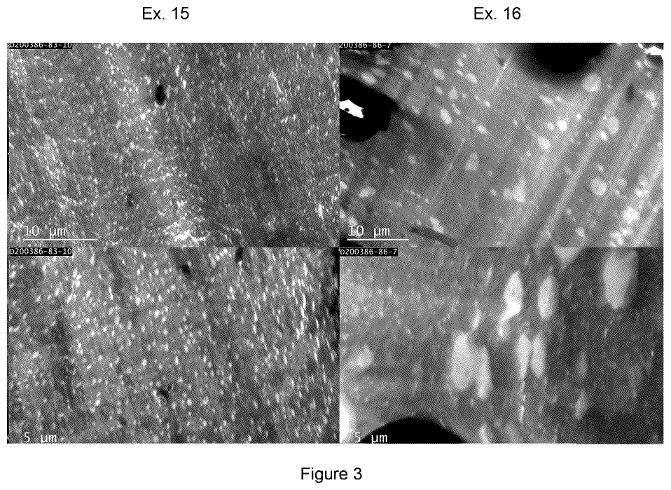

TEM images, as illustrated in FIG. 3, of samples 15 and 16 illustrate that sample 15, which was prepared using cube blending, demonstrated better dispersion of the thermoplastic copolyester elastomer than sample 16, which was prepared using an extruder. For instance, the TEM image of sample 15 indicates sub-micrometer size dispersions of the thermoplastic copolyester elastomer while the TEM image of sample 16 indicates dispersions of the thermoplastic copolyester elastomer in the range of approximately 2-3 micrometers.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A polyester composition comprising:
a polyester in an amount of from about 10 wt. % or more to about 75 wt. % or less based on the weight of polyester composition;
a thermoplastic copolyester elastomer containing hard segments and soft segments, wherein the thermoplastic copolyester elastomer is present in an amount of from about 3 wt. % or more to about 40 wt. % or less based on the weight of the polyester composition; and
a fibrous filler in an amount of from about 1 wt. % or more to about 40 wt. % or less based on the weight of the polyester composition;
wherein the polyester composition exhibits an Izod notched impact strength of from 5 kJ/m² or more to 40 kJ/m² or less as determined at a temperature of 23° C. in accordance with ISO 180/A1 (2006).

2. The polyester composition of claim 1, wherein the polyester comprises a thermoplastic polyester derived from an aliphatic diol and an aromatic dicarboxylic acid.

3. The polyester composition of claim 1, wherein the polyester comprises polyethylene terephthalate, polybutylene terephthalate, polycyclohexanedimethylene terephthalate, or a mixture thereof.

4. The polyester composition of claim 1, wherein the thermoplastic copolyester elastomer is a thermoplastic copolyetherester elastomer.

5. The polyester composition of claim 1, wherein the hard segments are derived from at least one aromatic dicarboxylic acid and/or a diester thereof and at least one diol containing from 2 to 15 carbon atoms.

6. The polyester composition of claim 5, wherein the aromatic dicarboxylic acid includes terephthalic acid, isophthalic acid, or a combination thereof and wherein the diol includes ethylene glycol, 1,4 butanediol, 1,3-propane diol, or a combination thereof.

7. The polyester composition of claim 1, wherein the soft segments are derived from at least one aromatic dicarboxylic acid and/or a diester thereof and at least one poly(alkylene oxide) glycol.

8. The polyester composition of claim 7, wherein the aromatic dicarboxylic acid includes terephthalic acid, isophthalic acid, or a combination thereof and wherein the poly(alkylene oxide) glycol includes poly(tetramethylene oxide) glycol, poly(trimethylene oxide) glycol, poly(propylene oxide) glycol, poly(ethylene oxide) glycol, poly(hexamethylene oxide) glycol, or a combination thereof.

9. The polyester composition of claim 1, wherein the thermoplastic copolyester elastomer comprises a thermoplastic copolyetherester elastomer prepared from monomers comprising (1) poly(tetramethylene oxide) glycol, (2) a dicarboxylic acid selected from isophthalic acid, terephthalic acid or a mixture thereof, and (3) a diol selected from 1,4-butanediol, 1,3-propanediol or a mixture thereof.

10. The polyester composition of claim 1, wherein the thermoplastic copolyester elastomer exhibits a Shore D hardness of about 60 or less, as determined in accordance with ISO 868:2003 (test time of 15 seconds) at a temperature of about 23° C.

11. The polyester composition of claim 1, wherein the fibrous filler comprises a glass fiber.

12. The polyester composition of claim 1, wherein the polyester is present in an amount of from about 30 wt. % or more to about 70 wt. % or less based on the weight of polyester composition and wherein the thermoplastic copolyester elastomer is present in an amount of from about 5 wt. % or more to about 20 wt. % or less based on the weight of the polyester composition, and wherein the fibrous filler is present in an amount of from about 10 wt. % or more to about 40 wt. % or less based on the weight of the polyester composition.

13. The polyester composition of claim 1, wherein the polyester composition further comprises an olefin acrylic acid copolymer.

14. The polyester composition of claim 13, wherein the olefin acrylic acid copolymer is present in an amount of from 0.1 wt. % or more to about 10 wt. % or less based on the weight of the polyester composition.

15. The polyester composition of claim 1, wherein the polyester composition further comprises an epoxy resin.

16. The polyester composition of claim 15, wherein the epoxy resin is present in an amount of from 0.01 wt. % or more to about 3 wt. % or less based on the weight of the polyester composition.

17. The polyester composition of claim 1, wherein the polyester composition further comprises one or more antioxidants, a lubricant, a plasticizer, a black pigment, or a mixture thereof.

18. The polyester composition of claim 1, wherein the polyester composition exhibits an Izod notched impact strength of from 8 kJ/m² or more to 20 kJ/m² or less as determined at a temperature of 23° C. in accordance with ISO 180/A1 (2006).

19. The polyester composition of claim 1, wherein the polyester composition exhibits a tensile strength of from about 10 MPa to about 300 MPa as determined at a temperature of 23° C. in accordance with ISO Test No. 527:2012, a tensile elongation of from about 0.3% or more to about 8% or less as determined at a temperature of 23° C. in accordance with ISO Test No. 527:2012, and/or a tensile modulus of from about 5,000 MPa or more to about 20,000 MPa or less as determined at a temperature of 23° C. in accordance with ISO Test No. 527:2012.

20. The polyester composition of claim 1, wherein the thermoplastic copolyester elastomer is present as a dispersed phase throughout the polyester and forms domains with a polyester continuous phase, wherein an average domain size of the thermoplastic copolyester elastomer is from 0.1 μm or more to about 10 μm or less.
